(19) United States
(12) Patent Application Publication
(10) Pub. No.: US 2010/0085787 A1
(43) Pub. Date: Apr. 8, 2010

(54) SYSTEM AND METHOD FOR POWERING A HYBRID ELECTRIC VEHICLE

(76) Inventors: Ajit Wasant Kane, Erie, PA (US); Rajendra Naik, Bangalore (IN)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(21) Appl. No.: 12/245,156

(22) Filed: Oct. 3, 2008

(51) Int. Cl. H02M 7/68

(52) U.S. Cl. 363/123

(57) ABSTRACT

A drive system including a first bus, a second bus, an AC bus, an energy storage device coupled to the first bus, the energy storage device configured to output a stored DC voltage to the first bus and configured to receive a charging voltage from the first bus, and a power converter electrically coupled between the first bus and the second bus, the power converter configured to convert a DC voltage on the first bus to a DC voltage suitable for the second bus and configured to convert a DC voltage on the second bus to a DC voltage suitable for the first bus and suitable for charging the energy storage device. The system further includes a voltage inverter coupled between the second bus and the AC bus, the voltage inverter configured to invert a DC voltage on the second bus to an AC voltage suitable for the AC bus and configured to invert an AC voltage on the AC bus to a DC voltage suitable for the second bus to supply the DC voltage to the first bus.

### BACKGROUND

1. Technical Field

The invention relates generally to hybrid electric vehicles, and more specifically to a motor drive system for hybrid electric vehicles.

2. Discussion of Art

Hybrid electric vehicles can combine an internal combustion engine and an electric motor that may be powered by one or more energy storage elements. Such a combination may increase overall fuel efficiency by enabling the combustion engine and the electric motor to each operate in ranges of increased efficiency. Electric motors are efficient at accelerating from a standing start, while combustion engines are efficient at sustained periods of constant engine operation, such as in highway driving. Having an electric motor to boost initial acceleration allows combustion engines in hybrid vehicles to be smaller and more fuel efficient.

Electronic systems used to drive the electric motor, or motor/generator in hybrid systems, may include a pre-charge circuit having a battery and a relay, a low-side energy storage element, a low voltage to high voltage converter, a high-side energy storage element, and a voltage inverter.

To operate the hybrid or electric vehicle drive system efficiently, it is advantageous to operate at higher line to line voltages thereby reducing the current to the motor and the losses in the motor-inverter system. To do this, a higher voltage is placed on the DC bus driving the inverter. As a result, the energy storage element may need to be rated at a higher DC link voltage. As the energy storage components currently available typically have low voltage ratings, several may need to be connected in series to handle the higher voltage. This may add to the cost of the vehicle. Another approach is to keep the main energy storage element at low voltage, and add another smaller energy storage element on the DC link to store the energy temporarily between the motor-inverter system and the main energy storage element. This approach may also add to the cost of the overall system.

It may be desirable to have a system that has aspects and features that differ from those systems that are currently available. It may be desirable to have a method that differs from those methods that are currently available.

### BRIEF DESCRIPTION OF THE INVENTION

According to an aspect of the invention, a drive system including a first bus, a second bus, an AC bus, an energy storage device coupled to the first bus, the energy storage device configured to output a stored DC voltage to the first bus and configured to receive a charging voltage from the first bus, and a power converter electrically coupled between the first bus and the second bus, the power converter configured to convert a DC voltage on the first bus to a DC voltage suitable for the second bus and configured to convert a DC voltage on the second bus to a DC voltage suitable for the first bus and suitable for charging the energy storage device. The system further includes a voltage inverter coupled between the second bus and the AC bus, the voltage inverter configured to invert a DC voltage on the second bus to an AC voltage suitable for the AC bus and configured to invert an AC voltage on the AC bus to a DC voltage suitable for the second bus to supply the DC voltage to the first bus.

In accordance with another aspect of the invention, a method of manufacturing that includes providing a batteryless electrical storage device configured to output a first DC voltage to a first DC bus and configured to receive a second DC voltage from the first DC bus, and coupling a boost converter between the first DC bus and a second DC bus, the boost converter configured to convert a DC voltage on one of the first and second DC buses to a different DC voltage on the other of the first and second DC buses. The method further includes coupling a voltage inverter between the second DC bus and an AC bus, the voltage inverter configured to invert a DC voltage on the second DC bus to an AC voltage on the AC bus to supply AC power to an electric motor and configured to invert an AC voltage on the AC bus to a DC voltage on the second DC bus to supply DC power to the electrical storage device.

In accordance with another aspect of the invention, a system including an electric motor, and a motor drive system including an energy storage device configured to output a DC voltage to a first DC interface and to receive a DC voltage from a voltage inverter via the first DC interface, the voltage inverter coupled to the electric motor and positioned between an AC interface and a second DC interface, the inverter configured to invert a DC voltage on the second DC interface to an AC voltage on the AC interface and configured to invert an AC voltage on the AC interface to a DC voltage on the second DC interface to provide DC power to the ultracapacitor, and a power converter coupled between the first DC interface and the second DC interface, the power converter configured to convert a DC voltage on one of the first and second DC interfaces to a different DC voltage on the other of the first and second DC interfaces.

Various other features and advantages will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a schematic diagram of a motor drive system according to an embodiment of the invention.

FIG. 2 is a schematic diagram of a motor drive system according to an embodiment of the invention.

FIG. 3 is a block diagram of a hybrid vehicle system incorporating an embodiment of the invention.

FIG. 4 is a block diagram of a hybrid vehicle system incorporating an embodiment of the invention.

### DETAILED DESCRIPTION

The invention includes embodiments that relate to hybrid vehicle systems and plug-in hybrid vehicles. The invention includes embodiments that relate to drive systems for hybrid vehicle electric motors. The invention also includes embodiments that relate to a method of manufacturing drive systems for hybrid vehicle electric motors.

According to one embodiment of the invention, a drive system including a first bus, a second bus, an AC bus, an energy storage device coupled to the first bus, the energy storage device configured to output a stored DC voltage to the first bus and configured to receive a charging voltage from the first bus, and a power converter electrically coupled between the first bus and the second bus, the power converter configured to convert a DC voltage on the first bus to a DC voltage suitable for the second bus and configured to convert a DC voltage on the second bus to a DC voltage suitable for the first bus and suitable for charging the energy storage device. The system further includes a voltage inverter coupled between the second bus and the AC bus, the voltage inverter configured to invert a DC voltage on the second bus to an AC voltage suitable for the AC bus and configured to invert an AC voltage on the AC bus to a DC voltage suitable for the second bus to supply the DC voltage to the first bus.

In accordance with another embodiment of the invention, a method of manufacturing that includes providing a batteryless electrical storage device configured to output a first DC voltage to a first DC bus and configured to receive a second DC voltage from the first DC bus, and coupling a boost converter between the first DC bus and a second DC bus, the boost converter configured to convert a DC voltage on one of the first and second DC buses to a different DC voltage on the other of the first and second DC buses. The method further includes coupling a voltage inverter between the second DC bus and an AC bus, the voltage inverter configured to invert a DC voltage on the second DC bus to an AC voltage on the AC bus to supply AC power to an electric motor and configured to invert an AC voltage on the AC bus to a DC voltage on the second DC bus to supply DC power to the electrical storage device.

In accordance with yet another embodiment of the invention, a system including an electric motor, and a motor drive system including an energy storage device configured to output a DC voltage to a first DC interface and to receive a DC voltage from a voltage inverter via the first DC interface, the voltage inverter coupled to the electric motor and positioned between an AC interface and a second DC interface, the inverter configured to invert a DC voltage on the second DC interface to an AC voltage on the AC interface and configured to invert an AC voltage on the AC interface to a DC voltage on the second DC interface to provide DC power to the ultracapacitor, and a power converter coupled between the first DC interface and the second DC interface, the power converter configured to convert a DC voltage on one of the first and second DC interfaces to a different DC voltage on the other of the first and second DC interfaces.

Ultracapacitors, or supercapacitors, are electrical energy storage devices that offer high energy density, which may be up to one thousand times or more greater than common high-capacity electrolytic capacitors. Ultracapacitors also exhibit higher cycling capability, faster charging times, and longer life when compared to batteries. Fast charging times and stability over a wide temperature range make ultracapacitors suitable for use in regenerative braking applications and as replacements for batteries in vehicular and other applications.

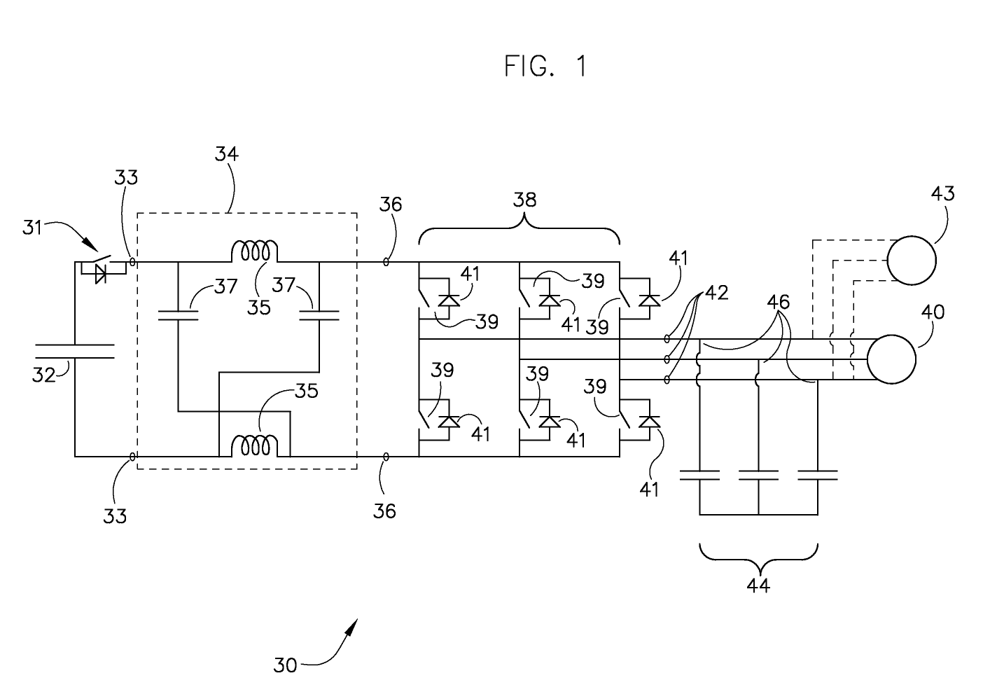

Referring to FIG. 1, an embodiment of the invention includes a motor drive system 30 having an ultracapacitor 32 as the primary electrical energy supply for the system 30, though one skilled in the art will recognize that other energy storage devices such as a battery, a fuel cell, a rectifier, an inductor, a capacitor, or a combination thereof may also work in system 30. In an embodiment of the invention, ultracapacitor 32 is configured to operate at approximately 140 to 200 volts DC. Ultracapacitor 32 is coupled to a parallel diode/transistor pair 31, which is coupled to an impedance-fed power converter, or z-source converter, 34 via a first DC bus, or interface 33.

System 30 includes a voltage inverter 38 having six voltage-inverter transistors 39, each transistor 39 in parallel with a respective diode 41. Transistors 39 each have a gate (not shown) controlled by reference signals, for example, by switching frequency of the signals applied thereto. The inverter 38 is coupled to the power converter 34 via a second DC bus, or interface 36.

System 30 includes a bank of starting capacitors 44 coupled to the voltage inverter 38 via an AC bus, or interface 42. An AC element 40 is coupled to the voltage inverter 38 via AC bus 42 and via output terminals 46. In one embodiment, AC element 40 is an electric motor/generator. In an alternate embodiment, element 40 is an electric motor. In this alternate embodiment, an electric generator, illustrated in phantom as element 43, is separately included in system 30 and coupled to voltage inverter 38 through AC bus 42 as illustrated in FIG. 1.

In operation, referring still to FIG. 1, a voltage on ultracapacitor 32 is boosted by the impedance-fed power converter 34 and converted to an AC voltage by voltage inverter 38 to a level suitable to operate electric motor/generator 40. System 30 is also configured to charge ultracapacitor 32 using electric motor/generator 40 via the voltage inverter 38 and the power converter 34.

The impedance-fed, or impedance-source, power converter 34 in conjunction with voltage inverter 38 acts as a boost, or step-up, converter increasing the DC voltage from the first DC bus 33. Voltage inverter 38 also functions as a DC-to-AC converter. Impedance-fed power converter 34 includes inductors 35 and capacitors 37 that, whether coupled to a voltage source or current source, can tolerate open circuits and short-circuits, or shoot-throughs, in a leg of the inverter without damaging any of the transistors 39 in that leg. In this embodiment, shoot-throughs are intentionally implemented in z-source inverters because it is in the shoot-through state that impedance-fed power converter 34 provides amplification of the ultracapacitor 32 voltage from first DC bus 33. The amplified voltage from first DC bus 33 is output to second DC bus 36.

Impedance-fed power converter 34 includes a two-port network with two inductors 35 and two capacitors 37 in an X-shaped configuration to provide an impedance source to ultracapacitor 32 via the first DC bus 33 and voltage inverter 38 via the second DC bus 36. The impedance-fed power converter 34/voltage inverter 38 combination can provide AC-to-DC, DC-to-AC, DC-to-DC, and AC-to-AC conversions.

The voltage boost provided by the impedance-fed power converter 34 and multi-phase switching voltage inverter 38 allows for a wide range of AC output voltages that can be generated from a non-zero DC supply voltage. The shoot-through state, which, generally, cannot be used with conventional power converters (e.g., buck-boost converters), boosts the DC capacitor 37 voltage while producing no voltage across electric motor 40. The more time the circuit spends in the shoot-through state, the higher the DC output of power converter 34. However, there is a limit to the time for which the circuit can be in the shoot through state. That time limit dictates a maximum voltage boost that can be provided by power converter 34, and, correspondingly, the maximum AC voltage output of voltage inverter 38. As the amount of power dissipated in the circuit increases, the power rating of the electrical components in the circuit may increase correspondingly.

In the embodiment of FIG. 1, ultracapacitor 32 has some initial voltage, for example, in the range of 140 to 200 volts which is output to first DC bus 33. In operation, power converter 34 boosts the ultracapacitor 32 voltage on first DC bus 33 to a higher voltage, for example 650 volts DC, which is output to second DC bus 36. Voltage inverter 38 is configured to convert the 650-volt DC signal into an AC voltage, for example 400 volts AC, which is output to AC bus 42 to power induction motor/generator 40. The 400-volt terminal voltage on motor/generator 40 results in a proportionately lower current through voltage inverter 38 and the motor/generator 40 combination. As a result, components for voltage inverter 38 may have a lower current rating than would be possible for systems operating at a lower voltage and higher current. The above-mentioned voltages are exemplary, and one skilled in the art will recognize that the motor drive systems described herein is not limited to the exemplary voltages and may operate at voltages higher or lower than the exemplary voltages shown above.

Referring still to FIG. 1, power converter 34 is coupled to three-phase pulse-width-modulated (PWM) voltage inverter 38 which is capable of converting a DC voltage into a three-phase AC signal. However, one skilled in the art will recognize that voltage inverter 38 is not limited to three-phase operation and may include a number of phases greater or lesser than three.

AC motor/generator 40 is coupled to the three outputs of voltage inverter 38. According to an embodiment of the invention, AC motor/generator 40 comprises a three-phase induction motor, as induction motors have the capability to operate as induction generators when the rotor is rotated faster than its synchronous frequency. Thus, the motor and generator are combined into a single unit. However, alternate embodiments of the invention may feature the motor and generator as separate devices as described hereinabove, and one skilled in the art will recognize that other types of electric motors could also be used in the invention.

In the motor drive system of FIG. 1, when the electrical power produced by electric generator 40 exceeds the power requirements of the system, excess power can be used to charge ultracapacitor 32. During recharging, voltage inverter 38 acts as a rectifier converting AC voltage from motor/generator 40 to a DC voltage suitable for ultracapacitor 32, and the transistor of diode/transistor pair 31 is closed.

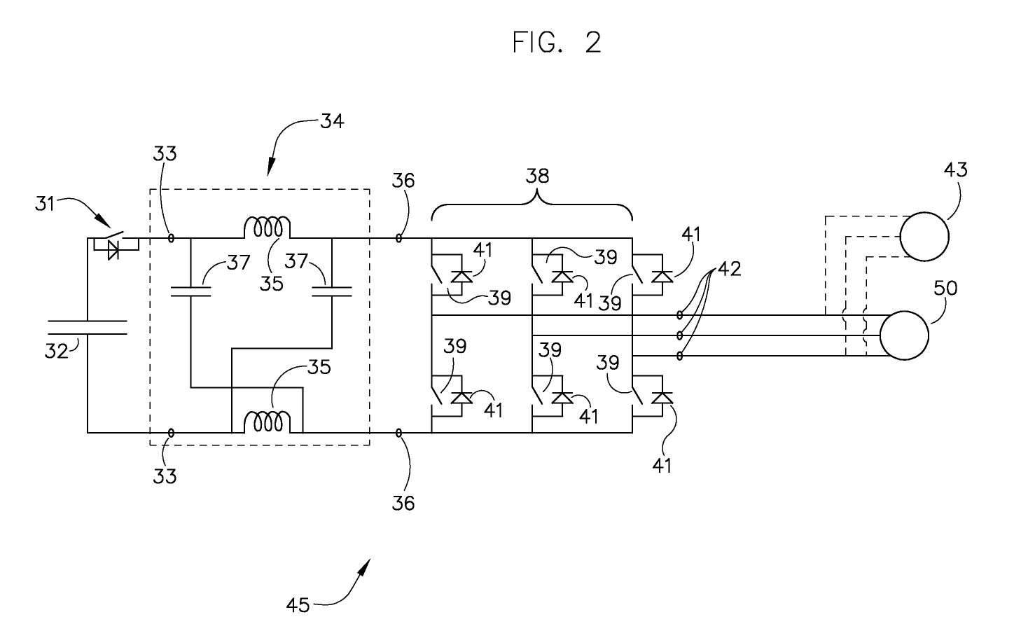

Hybrid vehicle drive systems may include a “prime mover” to power the drive system and power the hybrid circuit and provide mechanical energy to, for instance, the motor/generator 40 of FIG. 2. The prime mover may be an internal combustion engine and could be a gasoline-powered engine, diesel-powered engine, or a gas turbine engine. However, embodiments of the invention are not limited to those using internal combustion engines. It is contemplated that other types of engines capable of supplying mechanical energy could function as prime mover.

FIG. 2 illustrates another embodiment of the invention and illustrates a motor drive system 45 having an interior permanent magnet (IPM) motor/generator 50. In contrast to the embodiment illustrated in FIG. 1, this embodiment does not include starting capacitors 44, as the magnets in the IPM motor/generator are capable of generating a magnetizing current. In this embodiment, IPM motor/generator 50 can function as a motor by drawing power from ultracapacitor 32. However, IPM motor/generator 50 can also operate as a generator using an internal combustion engine (not shown) to power the generator rotor which produces an electric current to recharge ultracapacitor 32. When recharging ultracapacitor 32, voltage inverter 38 is controlled to act as a rectifier taking the AC output of generator 50 from AC bus 42 and converting it to a DC voltage output to second DC bus 36. The DC current flows to ultracapacitor 32 via first DC bus 33 through impedance-fed power converter 34 and through the closed transistor of diode/transistor pair 31. In an alternate embodiment, element 50 is an electric motor. In this alternate embodiment, an electric generator, illustrated in phantom as element 43, is separately included in system 45 and coupled to voltage inverter 38 through AC bus 42 as illustrated in FIG. 2.

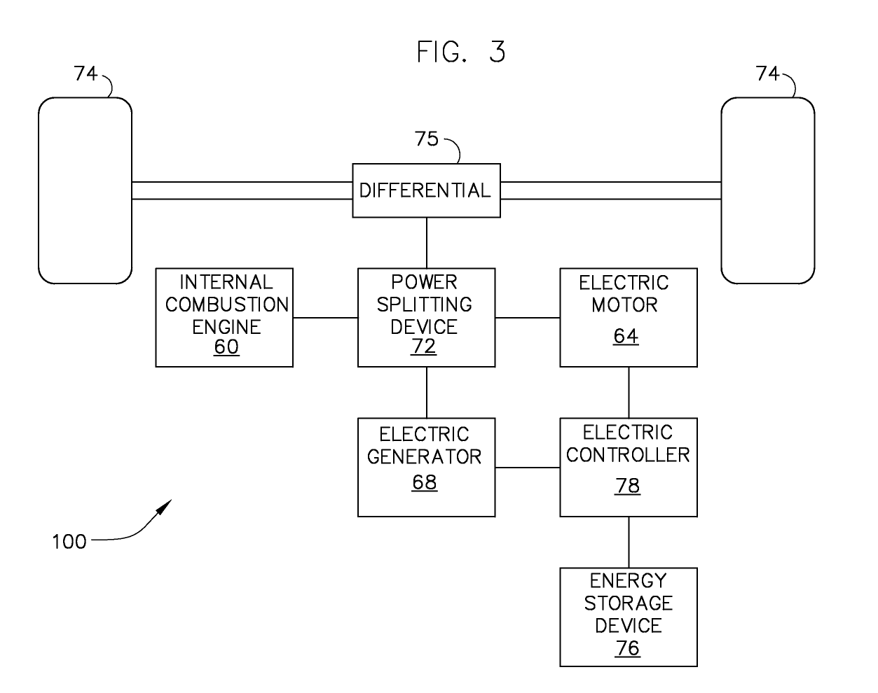

The block diagram of FIG. 3 shows a hybrid vehicle system 100 incorporating an embodiment of the invention. Hybrid vehicle system 100 includes an internal combustion engine 60, an electric motor 64, and an electric generator 68, each of which is coupled to a power splitting device (PSD) 72 which permits delivery of power to a set of wheels 74 from combustion engine 60 and electric motor 64 separately or in combination. Output shafts from engine 60, motor 64, and generator 68 are coupled to gears of PSD 72.

The electric motor 64 drives the wheels 74 through a differential 75 and may be driven by either system 30 or system 45 illustrated in FIGS. 1 and 2 where motor 64 corresponds to one of electric motors 40 and 50, respectively. Generator 68 can recharge ultracapacitor 32 in FIGS. 1 and 2 where generator 68 corresponds to generator 43 therein. Based on the function performed (i.e., accelerating, cruising, coasting, idling, or braking), electronic controller 78 determines the proper ratio of power from electric motor 64 and combustion engine 60 for driving the wheels 74. For example, to save fuel, combustion engine 60 may be shut off during idling and coasting and may be restarted when accelerating. Drawing power from an energy storage device 76, generator 68 may act as a motor during acceleration and also provides the power to start combustion engine 60. However, electronic controller 78 switches generator 68 to generator mode during cruising, coasting and braking. Electronic controller 78 determines whether the power generated by generator 68 goes directly to electric motor 64 or to recharge energy storage device 76. Energy storage device 76 can be, for example, an ultracapacitor or a fuel cell.

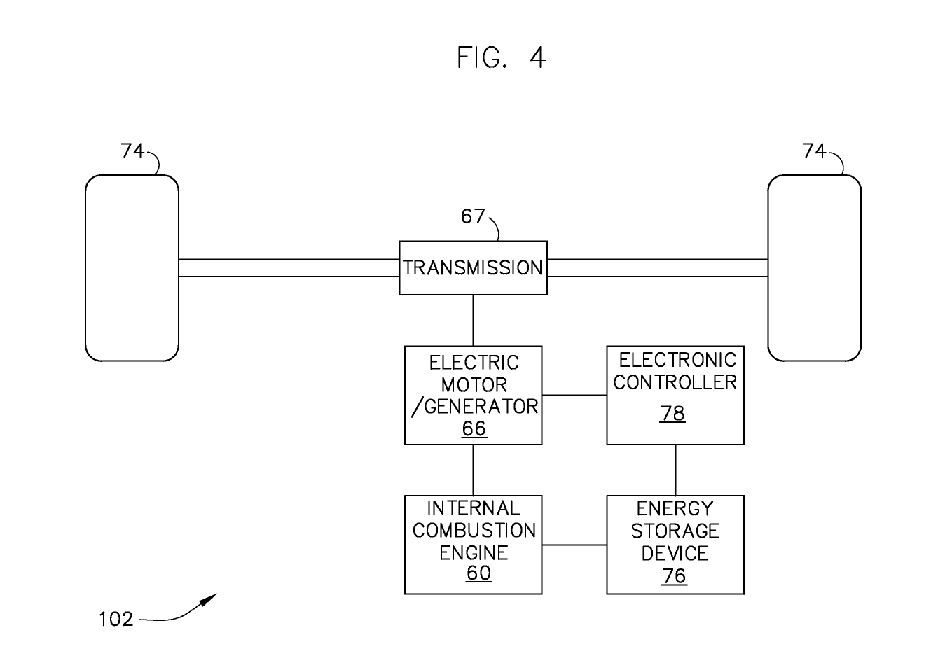

FIG. 4 illustrates a hybrid vehicle system 102, incorporating an embodiment of the invention, in which the electric motor and electric generator are combined into a single unit. An electric motor/generator 66 drives a pair of wheels 74 through a transmission 67. In FIGS. 2 and 3, electric motor/generator 40 and 50, respectively, perform the function of motor/generator 66 in the system of FIG. 4. Similarly, internal combustion engine 60 can also drive the wheels 74 through transmission 67. Electronic controller 78 determines how to most efficiently divide the work of driving the wheels 74 between combustion engine 60 and electric motor/generator 66. Additionally, electronic controller 78 determines when to run electric motor/generator 66 in generator mode using combustion engine 60 to power the generator 66 to charge an energy storage device 76. Energy storage device 76 can be, for example, an ultracapacitor or a fuel cell.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A drive system comprising:
a first bus;
a second bus;
an AC bus;
an energy storage device coupled to the first bus, the energy storage device configured to output a stored DC voltage to the first bus and configured to receive a charging voltage from the first bus;
a power converter electrically coupled between the first bus and the second bus, the power converter configured to convert a DC voltage on the first bus to a DC voltage suitable for the second bus and configured to convert a DC voltage on the second bus to a DC voltage suitable for the first bus and suitable for charging the energy storage device; and
a voltage inverter coupled between the second bus and the AC bus, the voltage inverter configured to invert a DC voltage on the second bus to an AC voltage suitable for the AC bus and configured to invert an AC voltage on the AC bus to a DC voltage suitable for the second bus to supply the DC voltage to the first bus.

2. The drive system of claim 1, further comprising an electric generator coupled to the AC bus.

3. The drive system of claim 2, comprising a plurality of starting capacitors coupled to the electric generator; wherein the electric generator comprises an induction generator.

4. The drive system of claim 1, wherein the second DC voltage is greater than the first DC voltage.

5. The drive system of claim 1, comprising a transistor and a diode coupled in parallel between the energy storage device and the power converter.

6. The drive system of claim 1, wherein the power converter is a z-source power converter.

7. The drive system of claim 6, wherein the energy storage device is an ultracapacitor.

8. The drive system of claim 1, further comprising an electric motor coupled to the AC bus, the electric motor configured to receive an AC voltage from the AC bus and configured to generate and output an AC voltage to the AC bus.

9. The drive system of claim 8, wherein the electric motor is configured to operate at a line-to-line voltage of at least 400 volts.

10. The drive system of claim 8, wherein the electric motor comprises an interior permanent magnet machine.

11. The drive system of claim 1, wherein the voltage inverter comprises a pulse-width-modulated (PWM) inverter.

12. The drive system of claim 1, wherein the second bus is configured to

13. A method of manufacturing comprising:
providing a batteryless electrical storage device configured to output a first DC voltage to a first DC bus and configured to receive a second DC voltage from the first DC bus;
coupling a boost converter between the first DC bus and a second DC bus, the boost converter configured to convert a DC voltage on one of the first and second DC buses to a different DC voltage on the other of the first and second DC buses; and
coupling a voltage inverter between the second DC bus and an AC bus, the voltage inverter configured to invert a DC voltage on the second DC bus to an AC voltage on the AC bus to supply AC power to an electric motor and configured to invert an AC voltage on the AC bus to a DC voltage on the second DC bus to supply DC power to the electrical storage device.

14. The method of claim 13, further comprising coupling an AC generator to the AC bus.

15. The method of claim 14, further comprising coupling a plurality of starting capacitors to the AC bus; and wherein coupling the AC generator to the AC bus comprises coupling a three-phase induction generator to the AC bus.

16. The method of claim 13, wherein providing the batteryless electrical storage device comprises providing an ultracapacitor.

17. The method of claim 13, wherein coupling the boost converter comprises coupling an impedance-source voltage converter between the first DC bus and the second DC bus.

18. A system comprising:
an electric motor; and
a motor drive system comprising:
an energy storage device configured to output a DC voltage to a first DC interface and to receive a DC voltage from a voltage inverter via the first DC interface;
the voltage inverter coupled to the electric motor and positioned between an AC interface and a second DC interface, the inverter configured to invert a DC voltage on the second DC interface to an AC voltage on the AC interface and configured to invert an AC voltage on the AC interface to a DC voltage on the second DC interface to provide DC power to the ultracapacitor; and
a power converter coupled between the first DC interface and the second DC interface, the power converter configured to convert a DC voltage on one of the first and second DC interfaces to a different DC voltage on the other of the first and second DC interfaces.

19. The system of claim 18 wherein the system is one of a hybrid electric vehicle system and a plug-in hybrid vehicle system and further comprises:
a plurality of starting capacitors coupled to the AC interface; and
a three-phase induction generator coupled to the AC interface.

20. The system of claim 18, wherein the system is a hybrid electric vehicle system and further comprises an electronic controller configured to regulate the flow of electrical energy to the energy storage device.

21. The system of claim 18, wherein the power converter comprises an impedance-source power converter.

22. The system of claim 18, wherein the DC voltage on the second interface is greater in magnitude than the DC voltage on the first interface.

23. The system of claim 18, wherein the energy storage device is an ultracapacitor.
